(19) United States
(12) Patent Application Publication
(10) Pub. No.: US 2010/0065344 A1
(43) Pub. Date: Mar. 18, 2010

(54) Self Propelled Electric Vehicle Recharging Trailer

(76) Inventor: John K. COLLINGS, III, Mableton, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 12/557,788

(22) Filed: Sep. 11, 2009

Related U.S. Application Data
(60) Provisional application No. 61/096,421, filed on Sep. 12, 2008.

(51) Int. Cl. B60L 9/00; B62M 7/14; B60T 7/12

(52) U.S. Cl. 180/2.1; 180/11; 701/96

(57) ABSTRACT

A recharging trailer for applying electrical energy to an electric vehicle has an electrical power coupling. The recharging trailer includes a trailer frame configured to be coupled to the electronic vehicle. An electrical generation unit is disposed on the trailer and is configured generate electrical power. The electrical generation unit is also configured to be electrically coupled to the electrical power coupling of the electric vehicle. A trailer propulsion unit is configured to propel the trailer while the electrical vehicle is moving so that the trailer moves without applying a substantial load to the electric vehicle.

### CROSS-REFERENCE TO RELATED APPLICATION(S)

This application claims the benefit of U.S. Provisional Patent Application Ser. No. 61/096,421, filed Sep. 12, 2008, the entirety of which is hereby incorporated herein by reference.

### BACKGROUND OF THE INVENTION

1. Field of the Invention

The present invention relates to support systems for electric vehicles and, more specifically, to a trailer configured to provide electrical power to an electric vehicle.

2. Description of the Prior Art

Other than cost, electric vehicles have not achieved the utility of gasoline or diesel powered vehicles for of two important reasons: (1) the power density of current and expected battery technology is far less than gasoline or diesel fuel; and (2) the automobile market is extensively served by ubiquitous fueling stations where, in about ten minutes, approximately 400 miles of travel fuel can be obtained. Yet in absolute local energy terms electric vehicles are about five times more efficient than internal combustion vehicles. This is because internal combustion engines are only approximately 30% thermally efficient and transmissions are only about 50% efficient, whereas purely electric vehicles have an overall efficiency of about 80%. This does not take into account the total efficiency of delivering the electric power to the electric vehicle on a local basis, which is also highly efficient.

The current generation of electric vehicles generally falls into two categories, pure electric vehicles and extended range (also known as hybrid) vehicles. Extended range electric vehicles have a primary electric drive with associated batteries and an onboard internal combustion engine coupled to an electric generator. The extended range electric vehicles have the distinct advantage of allowing unlimited travel, as they have no greater risk of running out of fuel than a traditional internal combustion powered vehicle. These advantages come at the costs of approximately one third higher vehicle weight and price. The vehicle's suspension, transmission, primary motor all must be designed for the additional weight of a redundant drive train and its fuel. While the result provides great utility it also provides substantial compromises in the vehicles electric only range and increase in price.

Extended range electric vehicles today have an electric-only driving range of about 40 miles and less if the driving is at highway speeds. Pure electric vehicles have a driving range of 100 to 200 miles and about a third less if the driving is at highway speeds. Pure electrics gain this advantage by trading some of their weight savings for extra batteries. But a full recharge even at a 40 amp 220 volt class two charging station takes over four hours. Therefore the vehicle has little utility for any non-commuter travel, even though for the majority of vehicles this kind of travel makes up a small portion of the vehicles total miles driven. Yet at the time of purchase a potential owner must consciously forego this type of travel utility, therefore the current pure electric vehicles are relegated to commuter or second vehicle use. This substantially reduces the vehicles general appeal.

While there is much talk and work on quick charging batteries and stations to enable extended travel in pure electric vehicles, it will be decades before electric vehicle technology and infrastructure will match internal combustion engine powered vehicles and existing fueling stations.

An obvious and tried solution to this problem is to attach a combustion based generator to the electric vehicle only when an extended range capability is needed. This is called a range extending trailer. While this solution works, it presents cost, safety, utility and performance problems. The core issue is that all of the motor, drive train and suspension systems must be built to accommodate the weight of the temporary combustion power system or else the combined vehicle suffers substantial performance and maintenance issues. By the time this is done one might as well put in the combustion engine permanently and build an extended range vehicle. But then the solution is back to one with a reduced the electric only range and a third more cost.

In the existing market of internal combustion engine driven vehicles fuel is obtained by the vehicle traveling to a gasoline station and filling up the fuel tank. This is acceptable as the fueling takes little time or effort. Electric vehicles currently take one to eight hours to charge their batteries. Because of this lengthy “fueling” time electric vehicles will be charged over night and when the vehicle is parked during the day, typically at the vehicle owner's place of business. Since electricity is already distributed to virtually all these locations this scenario is plausible, except for one major issue. Paying and accounting for the charging at the vehicle owners home is not a problem as the vehicle owner also owns and pays for the electricity used at the home. When the vehicle owner charges at any location other than their home this is not true. The electric vehicle owner has no way of accurately accounting for the charging during the day or when away from home. The current proposed solution for this is to deploy “for hire” charging stations at non residential locations. This requires a dedicated electric meter, a mandatory communications network connection for accounting and administration and installation of the charging station. The problem is that for real acceptance of the electric vehicle (and the subsequent mass appeal and deployment of electric vehicles) there must be real convenience in using the vehicle and that means a vastly greater number of electric charging stations then there are electric vehicles to ensure the vehicle owner they can go where they want. It is a “chicken or the egg” deployment problem. The cost of deploying many times more dedicated electric meters, circuits and transaction equipment than there are electric vehicles is potentially an issue that can substantially restrain the growth of the electric vehicle market, and the great societal benefits that accompany that industries emergence.

Other than the existing “for hire” charging stations with their dedicated meters, the electric vehicle manufacturers solve the lack of charging station availability by making the vehicles hybrids, with combustion engines as a back up. While this works, combustions engines cost two to four times as much as a motive force when compared to electricity. The onboard combustion engine also has a substantially greater carbon output then the electric generation plants and this difference will grow greater as cleaner generation comes on line. So for a hybrid owner to take full advantage of the vehicle and all its promises they must use electricity.

As the electric vehicle fleet emerges new owners will immediately want to charge at their current daily destinations. Asking those destinations to install a costly “for hire” charging station will likely not happen. Rather, if the vehicle owner could initially use an extension cord and plug into any AC receptacle at the host location without fear that they are “stealing” electricity then both entities would be satisfied.

Currently the electric vehicle industry is anticipating un-metered, or “for hire” charging stations to supply electricity to the fleet. The primary issue associated with the un-metered charging sites is that while the fleet is small the monetary affect of the vehicle charging on random or consistent host charging sites not operated by the vehicle driver is inconsequential. As the fleet grows, this will change. The current anticipated method to address unregulated charging is to install “for hire” charging stations. These stations rely on a means for the charging vehicle owner to identify themselves to the charging station so as billing can be performed. The charging station is somehow networked to a central computer facility that approves the charging, meters the charging event, bills the identified account and then pays the owner of the charging station for the electricity used and a facilities fee to replay them for purchasing and operating the charging station.

In the currently planned charging system the vehicle doesn't know who is supplying the electricity and the supplying entity doesn't know which vehicle is being charged except by extrapolation from the paying credit card or user ID fob device. The two entities don't communicate. There are distinct, unique advantages by enabling this communication, specifically with power line carrier communications technology.

One of the major issues with the “for hire” charging stations is their installation. They require a credit card or ID fob reader and a meter at each charging point. In their current embodiment they require professional installation, set up and a network connection. These requirements can lead to a current cost of approximately $1,000 per charging point.

As the electric vehicle market emerges the vehicle owners will, for convenience reasons, want to charge at their work place. The work place will not want to offer free charging due to the expense. Likely, they will also not want to pay for a “for hire” charging station. This dilemma will reduce the usability of electric vehicles.

What is needed is an inexpensive, easy to implement way for homes and commercial establishments to provide charging services to electric vehicles without having to simply give the electricity away.

What the vehicle owner needs is their own electric meter to measure and account for the charging and a method to easily repay the host charging site.

Vehicle owners will prefer the system that gives them the most options at the lowest cost. The higher installation and operational cost of the currently proposed “for hire” systems will force host providers to charge more for the system than the vehicle/driver based system. They can still use the “for hire” systems if they choose but can also use the more widely deployed “at cost” systems which have virtually no cost.

Governmental revenue agencies will eventually need to tax electric vehicle charging to replace the gasoline fuel tariffs. This might simply be done by a mileage fee assessed annually at the time of vehicle registration. While plausible, this method would result in delays of revenue not currently experienced by government agencies and, more seriously, a large annual bill for the vehicle owner that might well be too high to immediately pay. This is why pay as you go is a much better option. Without a smart vehicle system with reporting the home charging issue isn't addressed. No one will pay for a commercial charging station at their home, and home will be the primary charging site.\

Therefore, there is a need for a cost effective and easily retrofitable electric car charging accounting and administration system.

Therefore, there is a need for a low cost, temporary internal combustion powered motive means for pure electric vehicles to use during extended travel that doesn't present the design, cost, safety and performance issues associated with an existing trailer based gas generator currently.

### SUMMARY OF THE INVENTION

The disadvantages of the prior art are overcome by the present invention which, in one aspect, is a recharging trailer for applying electrical energy to an electric vehicle having an electrical power coupling. The recharging trailer includes a trailer frame configured to be coupled to the electronic vehicle. An electrical generation unit is disposed on the trailer and is configured generate electrical power. The electrical generation unit is also configured to be electrically coupled to the electrical power coupling of the electric vehicle. A trailer propulsion unit is configured to propel the trailer while the electrical vehicle is moving so that the trailer moves without applying a substantial load to the electric vehicle.

In another aspect, the invention includes a load sensor that is configured periodically to sense changes of speed of the electric vehicle and that is configured to generate a vehicle speed signal representative thereof. A controller is responsive to the vehicle speed signal and is configured to adjust a parameter of the trailer propulsion unit so that the recharging trailer will have a speed that matches the speed of the electric vehicle. In this aspect the trailer propulsion unit includes a trailer-mounted electric motor that is electrically coupled to the electrical generation unit and that receives electrical power therefrom and a drive assembly coupled to the trailer-mounted electric motor. The drive assembly is configured to provide motive power to the at least one wheel of the trailer.

In yet another aspect, the invention is a method of providing electrical power to an electric vehicle in which electrical power is generated using an electrical generation unit mounted on a trailer that is mechanically coupled to the electric vehicle. At least some of the electrical power is supplied from the electrical generation unit to the electric vehicle. The trailer is propelled with a trailer propulsion unit. Changes in electric vehicle momentum are sensed periodically. A momentum of the trailer is adjusted in response to changes in electric vehicle momentum sensed in the sensing action.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is an elevational view of one embodiment an electric vehicle recharging trailer coupled to an electric vehicle.

FIG. 2 is a schematic diagram showing a generalized configuration of components in the embodiment shown in FIG. 1.

FIG. 3 is an elevational view of one embodiment of a coupling

FIGS. 4A-4B are elevational views of one embodiment of a coupling system.

FIGS. 5A-5C are schematic diagrams of different embodiments of generation units and propulsion units.

FIGS. 6A-6B are elevational vies of a system that allows the trailer to be self propelled when disconnected from a vehicle.

FIG. 7 is a schematic diagram of one embodiment of a vehicle recharging system.

FIG. 8 is a flowchart showing actions executed by a vehicle meter.

FIG. 9 is a flowchart showing actions executed by a recharge station.

FIG. 10 is a flowchart showing actions executed by a billing entity.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a”, “an,” and “the” includes plural reference, the meaning of “in” includes “in” and “on.”

In one embodiment, the self propelled trailer has sensors that determine the turning, acceleration and deceleration load the trailer is presenting to the host vehicle. Onboard microprocessors and controllers instantly adjust the trailers motive drive to minimize or eliminate the trailers load to the host vehicle, thus improving the general performance of the combined vehicle. Additionally, if the host is an electric vehicle and the trailers motive means is electric also, then the trailer could house an internal combustion engine driven generator or electric generating fuel cell device that could produce enough electricity to power the motive needs of the trailer and host electric vehicle.

In this manner electric vehicles could be designed for electric use only but be afforded, when needed, the flexibility of gasoline or diesel powered travel without the permanent need, and inefficiencies, of two motive systems. The invention described herein substantially solves the current utility short comings of pure electric vehicles, presents inconsequential changes in the design, primary use and performance of pure electric vehicles, is cost effective and is immediately implementable on any scale, thus affording pure electric vehicles full travel functionality.

The invention includes an electric self propelled trailer with a traditional gasoline or diesel generator or electric generating fuel cell combined with load or strain sensors in the devices frame connection hitch that control the trailers motive means with sensors to determine the trailers load imposition to the host vehicle with the intent of nullifying the load.

The device is not designed to push the host electric vehicle. This results in a trailer that presents virtually no load to the host electric vehicle during acceleration, travel and deceleration. This control system can also add substantial stability control schemes to the combined vehicle during abrupt turns, braking and collision events. The devices traditional gas powered electric generator or electric generating fuel cell provides the power for both the trailer and the host electric vehicle during travel. The device may include small batteries for short term power of the devices electric drive motors. The device then relies on its alternate electric generating ability to provide motive means to the combined vehicle as, the device is primarily intended for extended travel events. The trailer also provides trunk or storage space for the extended travel event. This is pertinent as the pure electric vehicles typically forego cargo carrying features in favor of smaller, lighter weight coaches. The invention can be applied to other existing trailer applications but its primary utility is in enabling unrestricted travel for pure electric vehicles. Additionally, the control scheme that results in a near zero load for the temporary power source can extend to more integrated control schemes incorporated into the host vehicle instead of the strain sensors in the connection hitch.

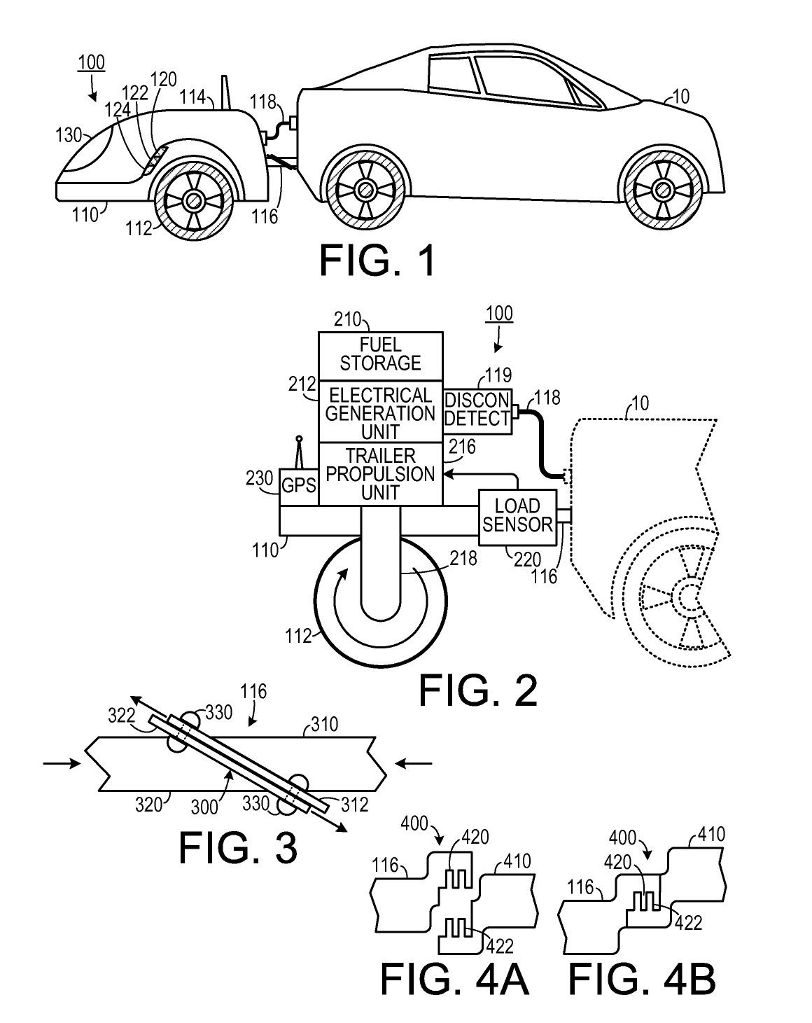

As shown in FIG. 1, one embodiment of a recharging trailer 100 that may be used to supply electrical energy to an electric vehicle 10 includes a trailer frame 110 that can be coupled to the electronic vehicle 10 via a mechanical coupling 116 and an electrical coupling 118. (It should be appreciated that the electrical coupling 118 could be integrated with, or even contained within, the mechanical coupling 116 without departing from the scope of the invention.) The trailer frame 110 is supported by at least one wheel 112 (typically, two wheels are used) and can be covered by an aerodynamic cowling 114 that protects the components internal to the trailer 100. A vehicle rear light set is mounted on each side of the rear of the trailer 100. The rear light set can include, for example, a brake light 120, a backing light 122 and a turn signal light 124. An access door 130 may also be provided to give the trailer 100 an extra cargo carrying capacity to supplement the trunk space of the electric vehicle 10.

One example of the trailer 100 with the cowling 114 removed is shown in FIG. 2. In this example, the trailer 100 includes a fuel storage tank 210 (such as a liquid fuel storage tank or a combustible gas storage tank) an electrical generation unit 212 and a trailer propulsion unit 216. The electrical generation unit 212 converts fuel in the fuel storage 210 into electrical energy and supplies the electrical energy to the electric vehicle 10 via the electrical coupling 118. The electrical generation unit 212 could include, for example: a mechanically operated electric generator and a drive engine; a fuel cell or an electrical energy storage system such as a battery (e.g., a lithium ion battery, a lead acid battery or other type of electro-chemical storage cell) or a super capacitor-based storage system.

The trailer propulsion unit 216 drives the trailer 100 via a drive assembly 218 that applies motive power to the wheels 112. A load sensor 220 (which in one example includes at least one strain sensor that periodically senses strain in the mechanical coupling 116 and generates a signal representative thereof) indicates the electric vehicle's 10 speed (and changes thereto) to the trailer propulsion unit 216. Based on the information received from the load sensor 220 (and possibly other sources, such as inputs from the electric vehicle's 10 engine computer or accelerometers on the trailer frame), a controller that controls the trailer propulsion unit 216 causes the trailer 100 to match the speed of the electric vehicle 10 so that the trailer 100 does not present a substantial load to the electric vehicle 10.

A global positioning system (GPS) locator 230 may be affixed to the trailer 100. The GPS locator generates and broadcasts a current location signal when the trailer is uncoupled from the electric vehicle. The current location signal can be used to locate a missing trailer as a theft deterrent. Typically, the GPS locator 230 would also include a disconnect detection circuit 119 that detects when the trailer 100 is disconnected from the electric vehicle 10 and that activates the GPS locator 230 when a disconnection is detected.

The mechanical coupling 116 can include a break-away mechanism 300, as shown in FIG. 3, that causes the trailer 100 to pass under the electric vehicle 10 in case of a head-on collision between the electric vehicle 10 and another vehicle. In one embodiment, the mechanism 300 includes a car-mounted portion 310 of the mechanical coupling 116 and a trailer-mounted portion 320 of the coupling 116. Attached to the car-mounted portion 310 is a first plate 312 that is mounted at a downward angle so that the forward portion of the first plate 312 is lower that an reward portion of the first plate 312. Similarly, a second plate 322 is attached to the trailer mounted portion 320. The second plate 322 is parallel to the first plate 312. The first plate 312 is coupled to the second plate 322 with a plurality of shear pins 330 that have sufficient strength to pull the trailer 100 under normal conditions, but that break when the shear force corresponding to a collision is applied thereto. Once the shear pins 330 break, the second plate 322 is driven under the first plate 312, which causes the trailer 100 to have a forward downwardly sloping attitude with respect to the electric vehicle 10 after a collision occurs. This will cause the trailer 100 to tend beneath the electric vehicle 10, thereby reducing the impact of the trailer 100 on the electric vehicle 10 as a result of a collision.

The mechanical coupling 116 can include an electric vehicle-specific coupler 400 as shown in FIGS. 4A and 4B, can include an electric vehicle-mounted coupler 410 that is incompatible with a standard trailer hitch. This feature will prevent improper attachment of the trailer 100 to the electric vehicle 10 and may also prevent casual theft of the trailer 100. In this embodiment, the vehicle-mounted coupler 410 includes a first non-standard attachment portion 422. Similarly, a trailer-mounted coupler 116 has a second non-standard attachment portion 420 that is complimentary in shape to the first non-standard attachment portion 422. This feature may be used in addition to the break-away mechanism 300 discussed above.

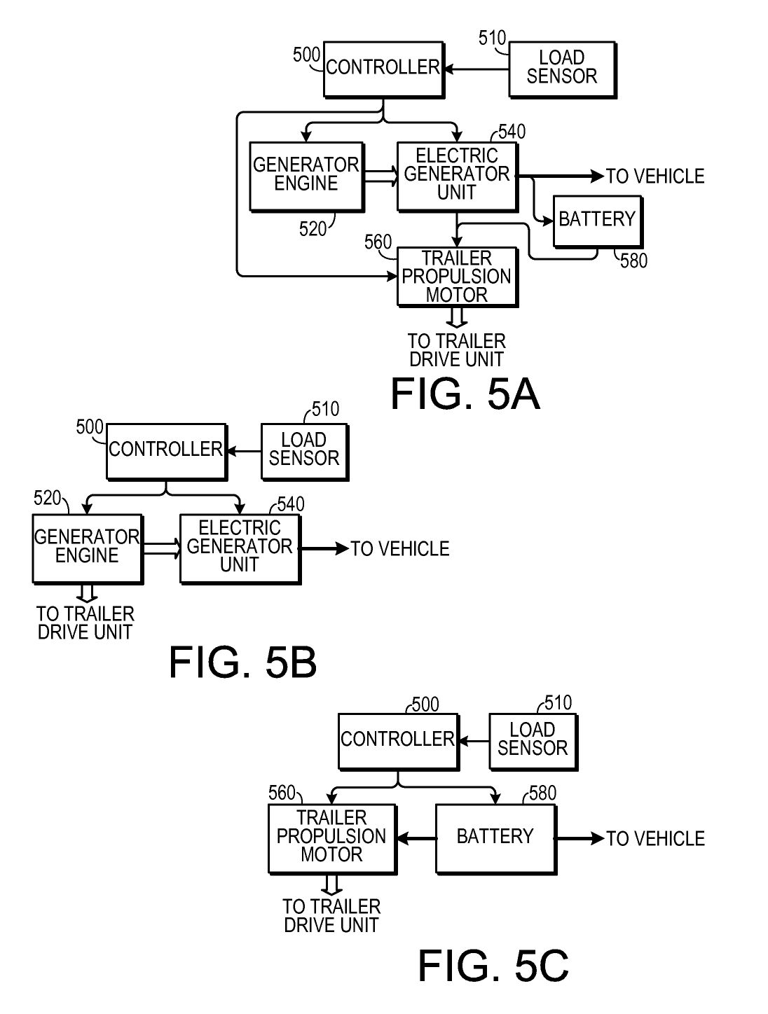

Three different configurations of the electrical generation unit and the trailer propulsion unit are shown in FIGS. 5A-5C. In each of these configurations, a load sensor 510 provides information regarding the electric vehicle speed (and, in certain embodiments, data regarding braking, gear shifting and other vehicle operational parameters) to a controller 500 (which could include a digital processor). As shown in FIG. 5A, in one embodiment, a generator engine 520 (which could be, for example, an internal combustion engine, a small gas turbine engine, or another type of mechanical engine) drives an electrical generator unit 540, which generates electricity supplied to the electric vehicle. The electrical generator unit 540 could also supply electricity to the trailer propulsion motor 560, a battery 580 or both. The trailer propulsion motor 560, which in this embodiment would be an electric motor, would supply mechanical power to the trailer drive assembly 218 (shown in FIG. 2), which would provide motive power to the wheels of the trailer. In this embodiment, the trailer operates in a manner similar to a conventional hybrid vehicle. Also, in one embodiment, the electrical generator unit 540 will have a capacity sufficient to recharge the batteries of the electric vehicle while the electric vehicle is in motion.

In the embodiment shown in FIG. 5B, the generator engine 520 drives both the electric generator unit 540 and the trailer drive assembly. In this case, the trailer is driven mechanically by the generator engine 520. This embodiment has an advantage of not requiring an additional trailer propulsion motor. However, the trailer drive assembly would be more complicated in this embodiment.

In another embodiment, shown in FIG. 5C, the trailer does not include a generator engine or an electric generator unit. In this embodiment, the trailer includes batteries 580 that are precharged before use. The batteries 580 supply electricity to both the electric vehicle and to the trailer propulsion motor 560 to drive the trailer. This embodiment is simpler that the above discussed embodiments, but the range of the electric vehicle and the trailer would be limited to the charge carrying capacity of the batteries 580.

As a safety measure, the disconnect detection circuit 119 (shown in FIG. 2) could also supply an indication to the controller 500 that prevents any electricity greater than a low voltage signal level from being transmitted to the electrical coupling 118.

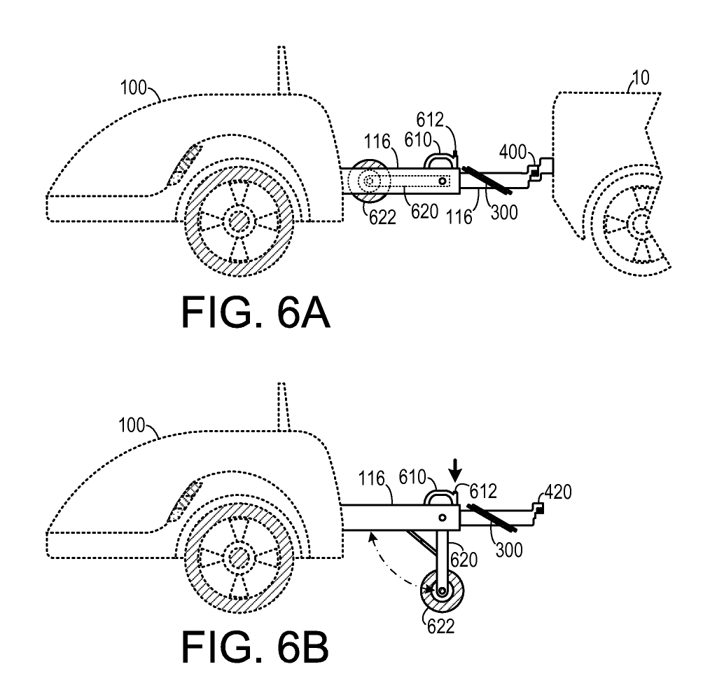

One embodiment, as shown in FIGS. 6A-6B, includes a mechanism that facilitates easy moving of the trailer 100 when it is disconnected from the electric vehicle 10. This embodiment includes a retractable wheel assembly 620 and a system for signaling the controller (as discussed with reference to FIGS. 5A-5C above) to cause the trailer 100 to move. While the trailer is connected to the electric vehicle 10, as shown in FIG. 5A, the retractable wheel assembly 620 would be in a retracted position. Once the trailer is disconnected, as shown in FIG. 5B, the wheel assembly 620 is extended so that the wheel 622 touches the ground, thereby providing three point stability to the trailer 100. A handle 610 on the mechanical coupling 116 allows the user to steer the trailer 100 and a button 612 on the handle 610 causes the controller to cause the trailer to move forward (additional controls could be used to cause the trailer to move backward). This feature makes it easier to move a disconnected trailer 100 around a lot or into a garage.

One specific embodiment includes the following components:

Frame—The general structure holding all the trailer components. This frame is typically not part of the general host vehicle frame.

Host vehicle connection hitch—This could be a traditional ball hitch but, due to the devices near zero imposed load to the host electric vehicle, it is likely that the connection hitch is more rigid. This hitch can be a releasable universal joint type with actual connection to the host vehicle being rigid.

Connection hitch strain or load sensors—These sensors could be in the connection assembly between the device and the host vehicle. They can take on many forms. The sensors could be stain sensors fitted in a rigid hitch connection. They could also be position style sensors in a spring loaded assembly that expands and contracts as the host vehicle accelerates and decelerates. Many different sensor types and assemblies could be used. These sensors may provide the tracking position of the device behind the host vehicle too. In this case the sensors would drive the position of a steering mechanism on the devices drive wheels to keep the device directly behind the host vehicle. The ultimate purpose is to sense the inertia load the device is imposing on the host vehicle at the current moment. These sensor(s) connect to the load controller which controls the devices electric motor drives for the devices wheels. In this manner the device follows the host vehicle with minimal load through all travel events. The only time the device would present a significant load to the host vehicle is when the combined vehicles acceleration or deceleration exceeded the devices own capabilities.

Other Trailer Sensors—In addition to the primary hitch load sensors the trailer could also employ accelerometers, speed and level position sensors. These sensors would add information to the load controller so as it can adjust the wheel drive motors responses to different driving situations. For example, when the trailer has no or little forward speed and the level sensor indicates a hill the load controller might slow down its control response to the primary load sensors so as to not produce a jerking motion of the trailer when slowly traveling up an incline. In another case the accelerometers may be able to detect a side skidding event during high speed or sharp turning and adjust the inside wheel drive to slow down to counter the skid much the same way that active control on the host vehicle might do. The expected primary use of the speed sensors would be to adjust the rate of change that the load controller uses to adjust the power output to the wheel drive motor(s).

Electric motor(s) for trailer motive means, brakes and trailer suspension—one embodiment of the device would employ an electric motor drive for each wheel. This embodiment of the device would employ two wheels, though a single wheel is also possible. The wheels would attach to the frame in a traditional leaf or wishbone style suspension. The single or dual individual electric motors would drive the devices wheels through a belt or gear drive to one or both wheels. The use of individual motors for each wheel would allow for differential drive control schemes. A single motor connected to a differential transaxle would likely be less expensive to manufacture. The single motor embodiment would then use the wheel brakes for stability control schemes

Internal combustion engine or alternate driven electric generator—The device would employ and alternate fuel electric generator. This embodiment would employ a gasoline or diesel driven electric generator, but would not exclude generators such as hydrogen fuel cell powered electric generators. The generator may be a DC or AC generator. The devices onboard electric requirements would primarily be DC. The AC conversion may be needed to supply motive and charging electric power for the host electric vehicle. The combustion engine or fuel cell would be used primarily to power the motive drive motors of the trailer and the host vehicle. The combustion engine or fuel cell would be controlled in part by the trailer motor controller, the load controller and the host vehicle electric power controller. Inputs from all three of these controllers would establish the operating output of the combustion engine or fuel cell electric generator. When the device is at rest or at slow (less than 5 mph) speeds the combustion engine or fuel cell electric generator would be turned off. Typically the electric generator will only operate once consistent travel speeds have been established or the onboard trailer batteries have been depleted.

Trailer batteries and capacitors—The trailers electric motors used for primary motive drive are initially driven by on board batteries and super capacitors but primarily driven by the onboard combustion or fuel cell driven electric generator. As the trailer is primarily used for longer travel trips where the host vehicles batteries cannot meet the travel needs it is assumed that most of the trailers travel will be consistent highway type travel. The trailers batteries (and, in some embodiments, super capacitors) would be used for acceleration and recuperative braking (deceleration) and short duration (<15 minutes) travel. The batteries and super capacitors would also be chosen for use because of their ability to provide near instant torque change to the trailer drive motor(s) to regulate load control. The trailer's batteries and super capacitors controlled by the load controller would be the primary means of adjusting motive power to eliminate the load of the trailer to the host vehicle. The trailer's onboard battery would typically require no more than 2 kWh capacity.

Fuel tank—The trailer will utilize a typical fuel tank for gasoline, diesel or hydrogen fuel storage.

Load controlling computer—In one embodiment, a load controller is the primary computer for the input of load and position sensors on the trailer. Its primary responsibility would be to determine the load the trailer is presenting to the host vehicle and adjust the output of the electric motor controller that drives the wheels electric motor so as the least load is presented to the host vehicle while adjusting the load in the smoothest manner to the host vehicle. This controller in combination with the host vehicle electric power supply controller controls the operation and output of the onboard generator.

Electric motor(s) controller—The load controller directly controls the wheels electric motor controller. The electric motor controller is a standard voltage and current adjusting controller as is currently found on electric vehicles.

Host vehicle electric power supply controller—The host vehicle electric power supply controller monitors and adjusts the voltage and current being provided to the host vehicle via the host vehicle electric power connection cable. This controller controls and limits the trailers on board generators output. This controller in combination with signals from the load controlling computer controls the onboard generators operation. During strong deceleration this controller will dramatically or completely reduce voltage and current flow to the host vehicle. This controller will also provide over current, short circuit and ground fault interruption circuits and mechanisms. This controller in conjunction with the load controller will restrict current flow to the host vehicle until a certain higher travel speed is reached.

Host vehicle electric power connection cable—This is the cable providing electricity from the trailer to the host vehicle. This cable will employ a high current, locking, waterproof, connection aware connector. Connection aware means that the connector will have a circuit to communicate with the host vehicle electric power supply controller to instruct it when a complete connection to the host vehicles connector is made. If a complete connection is not made then the host vehicle electric power supply controller will not provide any electric power to the cable.

Host vehicle remote display device—The host vehicle remote display device provides current and historic information to the occupants of the host vehicle as to the condition of the trailer. This device is typically, but not necessarily, wirelessly connected to the trailer in a bi-directional means. This device would indicate information such as generator fuel level, output, health and estimated time till refueling. Additionally this device could act as an electronic key for the trailer. If the device was not in communication with the trailer the trailer would not operate.

The host vehicle remote display device could also employ a unique safety feature. Many current vehicles have ultrasonic proximity sensors and back up cameras located on or about the rear bumper of the vehicle. The self propelled, load aware trailer could also have a camera and ultrasonic proximity sensors on its rear bumper. When the trailer senses reverse travel via the back light connections (if used) or via reverse load and motion the back up camera and proximity sensors, information would automatically be displayed on the host vehicle remote display devices screen.

Trailer stabilizing and parking leg—The stabilizing leg is an extendable/retractable leg typically positioned ahead of the center of gravity of the trailer and on the connection yoke to the host vehicle. It would include a small wheel at its base on a swivel to allow the trailer to be moved once disconnected from the host vehicle. When the stabilizing leg is extended a mechanism will send a signal to the load controlling computer to disengage from any load sensor input signals and not allow speeds in excess of a predetermined threshold.

Trailer hand maneuvering bar and load sensors—A trailer hand maneuvering bar is positioned typically on or about the connection yoke to the host vehicle and near the trailer stabilizing leg extension/retraction handle. The trailer hand maneuvering bar may be built into the stabilizing extension/retraction handle. The hand maneuvering bar allows a person to maneuver the trailer when it is disconnected from a host vehicle. The handle is vertical typically and has strain or load sensors at its based. The handle has a plunger style activation switch. When the handle is grasped and the plunger switch depressed the sensors at the base of the handle sense the persons directional input being placed on the top of the handle and relay that to the load controlling computer. The load controlling computer then drives the wheels electric motors to propel the trailer in the direction and speed the operator desires. Once the handle and plunger switch are released the trailer will stop and maintain its current position either through maintaining electric motor torque on the wheels or setting a brake mechanism. In this manner a person can disconnect the trailer from the host vehicle and easily maneuver the trailer into another location using the trailers own motive capabilities.

Wheel(s), Wheel drive or transmission—The trailer will likely use a two wheel drive system, possible with assisted steering to keep the trailer directly behind the host vehicle and to enable reverse travel without the normal trailer considerations. The trailer could employ a single wide drive wheel. This would be used with a rigid connection to the host vehicle instead of a pivoting connection. The wheels would be driven by the electric motor(s) via belt drive or a traditional automotive style differential axle mechanism. The wheels and transmission would utilize a traditional style automotive suspension.

Connection hitch vehicle position and vertical weight sensors—The trailer could employ, in addition to the primary load sensors, a set of sensors to assist in drivability performance. The use of a position sensor in the pivoting hitch when combined with a steering mechanism would allow for more direct tracking of the trailer behind the host vehicle during forward or reverse travel. A vertical weight sensor in the connection hitch measuring the amount of vertical weight the trailer presents to the rear suspension of the host vehicle could be combined with a mechanism to move another weight in trailer to offset this effect on the host vehicle. Since the trailer would also be used at times for its additional cargo area the trailer could not be designed always to be in forward and aft balance. The vertical weight sensor could be made to slide the trailers onboard batteries (a substantial amount of weight) via sliding tray mechanism forward and aft to minimize the vertical weight imposed on the host vehicle. The alternate engine and generator would be the single largest weight in the trailer in most embodiments. They may be mounted in the trailer in the forward or rear area of the trailer. They will be located as close as practical to the trailer axle/wheel(s) (the center of gravity of the trailer). The trailer electric drive batteries (the second heaviest components) would be mounted of the opposite end of the trailer. The batteries could be mounted on a sliding tray. Once the vehicle starts to move the onboard controller could command an electric worm drive to move the battery tray to the most balanced position. This reduction of vertical weight imposed on the host vehicle would allow for better combined vehicle performance and reduce the host vehicles sensations of a trailer during travel.

DC to DC voltage converter—The trailer could include a DC to DC voltage converter to adjust it host vehicle output voltage to suit the needs of different models of host electric vehicles. This would allow a single design to serve many different models of electric vehicle.

Trailer GPS, short range and wide area communications—The trailer could have several communications technologies on board. The controllers and operational electronics would send their telemetry via this short range wireless radio transceiver to the remote enunciator and controller in the host vehicle cab. The trailer would be equipped with a covert GPS system that would provide several functions. As the trailer could be used in a rental fleet business the GPS could, a remote enunciator could display the closets rental drop off or service location. Additionally, if the trailer where stolen the GPS could provide a wide area telemetry radio such as a cellular modem the trailer position so it could be relayed to authorities. The wide area telemetry could also be used for service or emergency roadside service. The wide area telemetry service could be built into the host vehicle and the trailer, via the short range wireless link that could provide the trailer diagnostics to a remote service center.

Breakaway hitch—The trailer would employ a break away hitch so that in the event of combined vehicle head on collision, the trailer would separate from the host vehicle and be forced under the leading host vehicle instead of into it or over it. This would be accomplished by using a connection hitch with two parallel plates connected to one another with shear pins. One plate would be attached to the hitch connection to the host vehicle. The other plate would be attached to the trailer yoke and frame. The plates would not be parallel to the road but angled forward down and aft (trailer side) up. In a severe collision, even though the trailer would be attempting to brake itself from the load change, the trailer might add to the accident damage by colliding with the host vehicle from the rear. This potential damage could be reduced by forcing the trailer under the host vehicle during such an accident. The parallel plates with shear pins in the trailer yoke should provide for such an action.

Given that electric vehicles require recharging, one additional embodiment includes a system that facilitates recharging of vehicles at remote locations (such as parking lots) and that permits billing for power consumed during recharging. For example, under such a system an office park or a shopping mall may offer recharge stations to allow employees and patrons to recharge their vehicles while the vehicles are parked.

Each charging station would be connected to the electric power grid under the account of the charging entity, which is the owner of the charging station. At a central location, the charging entity would have a circuit that identifies itself to the vehicle. This could be done through a power line carrier connection (e.g., X10) by which an identifying code is transmitted to a receiver in the vehicle via the power line. Alternately, an additional line could transmit this information to the vehicle. Alternately, this information could be transmitted by a wireless connection. Alternately, the vehicle could identify its location via a GPS system and correlate the location with the location of the charging station. The charging station could also receive an identification of the vehicle and verify that the vehicle has a valid account prior to allowing recharging.

Each vehicle would come equipped with an electric recharge meter. This meter would have the ability to record the identification of the recharge station and the amount of power (e.g., in kilowatt hours) consumed by the vehicle during a given charging session. This information would then be transmitted to a billing authority, such as the local electric utility. The vehicle owner would be billed for the amount of power consumed in the recharging and payment could be automatic, such as through a credit card or an automatic funds transfer from a bank account.

The owner of the recharge station would be credited in for the amount of power consumed. The billing authority could also bill the vehicle owner a service charge, which is paid to the recharging station owner.

This system offers the advantage of allowing an entity, such as an office park, to allow many different vehicles to recharge without having to maintain a separate meter for each recharging station and without having to incur the overhead of billing each vehicle owner for the power consumed for each recharge.

Below are functional descriptions of mechanisms and processes that provide a low cost, easily deployed and scalable system addressing the needs of the emerging international electric car fleet. Specifically, the system addresses the impending issues associated with charging electric vehicles at various locations not owned by the charging vehicle owner.

Primarily, the system exploits the use of low cost power line carrier transceivers to enable communications between the host site and the vehicles needing charging and therein recording the parties involved and details of the charging event so it can be accounted for. These host site and vehicle devices are subsequently coupled with other data storage and transfer devices. The resulting system allows for regulated and managed charging at virtually any host location. These communications are needed for a variety of reasons.

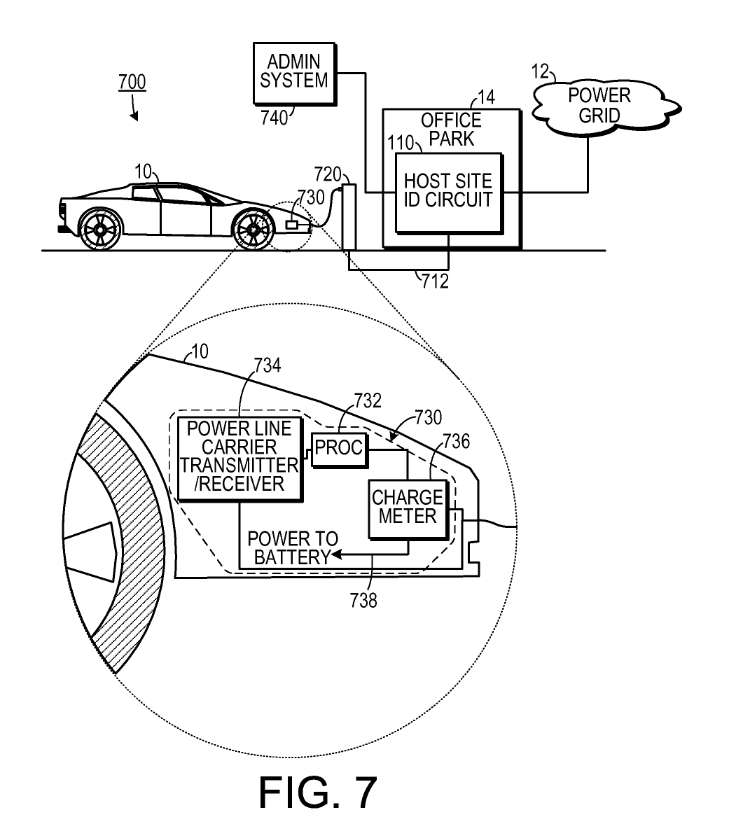

As shown in FIG. 7, one embodiment 700 provides a way for locations 14 coupled to the power grid 12 automatically and reliably to identify themselves to electric vehicles 10 that desire to charge at the site and provides an automatic means for the charging the vehicle 10 to reimburse the location 14 for the electricity used.

One embodiment includes three basis pieces; a charging vehicle adapter 730 (built in to the vehicle 10 or retrofitted in), a host site identifying device 710 connected to a charging station 720 and a central computerized administration system 740. The charging vehicle adapter 730 and the host site identifying device 710 communicate with each other via power line carrier technology via a power line 712. By using power line carrier technology for the local communications many convenience and cost advantages can be realized. By making the vehicle record the charging event and identify itself to the host charging site many accounting, administration and cost advantages may be realized.

In one embodiment, the charging vehicle adapter 730 would include a processor 732 a meter 736 that is configured to record the amount of power being transmitted to the battery 738 and a power line carrier transmitter and receiver 734 for receiving identification and other data from the host cite identification system 710 and for transmitting consumption and other data to the administration system 740.

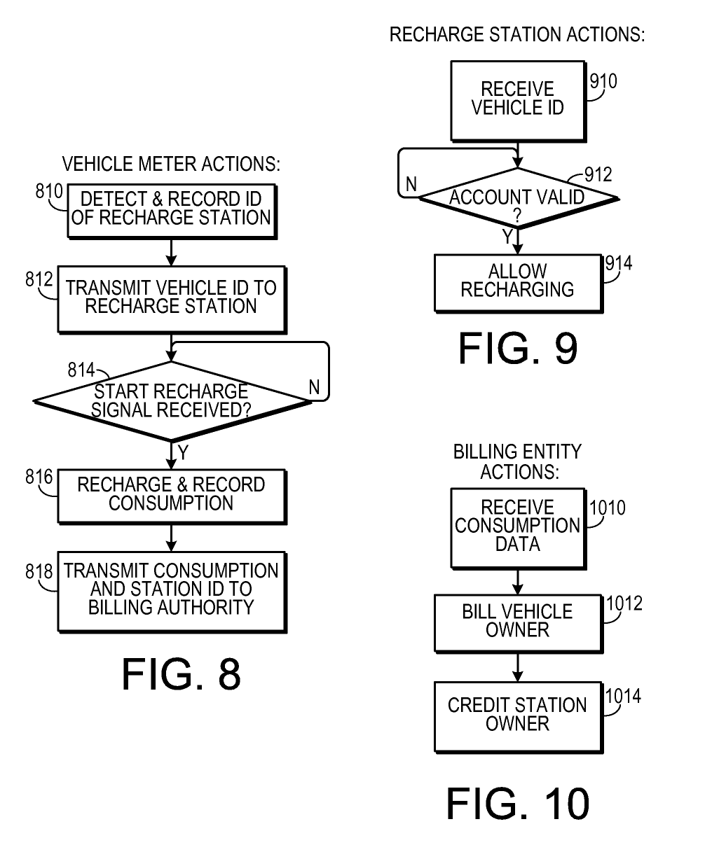

As shown in FIG. 8, the vehicle adapter takes several actions, including: detecting and recording an identification of a recharging station 810; transmitting a vehicle identification to the recharging station 812; determining if a “start recharging” signal is received 814; recharging the vehicle and recording the amount of power consumed 816; and transmitting consumption and the recharging station identification to the administration system 818.

The recharging station takes several actions, as shown in FIG. 9, including: receiving an identification from the vehicle being recharged 910; determining if the vehicle has a valid account 912; and allowing recharging of the vehicle 914 if it is a valid vehicle.

The administration system (which could be administered by an electric power utility) takes several actions, as shown in FIG. 10, including: receiving consumption data 1010 from the vehicle adapter; billing the vehicle owner for the power consumed 1012; and crediting the owner of the recharging station 1014 for the amount of power consumed.

The invention incorporates many security features to prevent electricity theft and system abuse. In one representative embodiment, to begin using the system the following process would occur:

The new electric vehicle owner would subscribe to the charging service and purchase a charging vehicle adapter. The charging adapter may be built into the vehicle. The charging vehicle adapter has a unique serial number embedded in its internal electronics and printed on the device itself. The charging vehicle adapter would come with an electronic key (maybe more than one) having bi-directional communications capability and non volatile data memory. The new charging service member would enroll their adapter serial number, electronic key(s) serial number and enter either their electric utility account number or a credit card number into the central administration system customer web site. The charging vehicle adapter has a bi directional power line communications system embedded in its internal electronics. The charging vehicle adapter device has a built in electric meter to record the exact amount of power used for the charging event. The charging vehicle adapter has an alpha numeric display, a keypad and an electronic key reader device embedded into the housing.

The new host charging site would order a site identifier device. The device has a unique serial number embedded in its internal electronics. The host site identifying device would have a bi-directional power line carrier communications ability. The device would likely have an Ethernet style connection. This would enable the host charging site device to be plugged into a router and make a TCPIP style connection to the central administration computer system. This may or may not be used by/at the host charging site. The host charging site identifier would be plugged into any AC receptacle in the host charging site. The host site device purchaser would use the central administration system customer web site to enter in the devices unique serial number, the sites address and the host site owners credit card number or electric utility account number. The host site would be added to the list of potential charging locations. The host charging site would be provided signage announcing their participation in the program.

A host charging site device will broadcast on a regular schedule (approximately every five seconds) its unique site ID via its built in power line carrier technology. This unique identifier transmission would be done in a prescribed format and protocol. The protocol would allow for a variety of communications exchanges between the host charging site and any member charging vehicle currently plugged into the host sites AC wiring. These communications exchanges would allow for:
Host charging site identification to the charging vehicle
Charging vehicle identification to host site device.
Upload of charging vehicle charging history
Download of current electricity costs to charging vehicle so as charging vehicle can elect to participate in charging at different times and conditions.
Download of load shedding requests to charging vehicle
Download of charging permission refresh

When a member vehicle parks at a member charging site the vehicle driver extends a standard electric extension cord from the vehicle to the charging site. They may plug into any AC receptacle as the host charging site device and the charging vehicle can communicate over the entire AC wiring of the host site up the host sites electric meter or transformer, but not beyond. This is a unique advantage of the system as it is virtually assured that the charging vehicle will properly identify the host charging site for reimbursement. This is especially critical is office and retail environments were places of business are in close proximity. This ability to associate the host charging site ID with the particular AC receptacle being used without installing dedicated circuits and receptacles greatly reduces deployment costs.

Once the charging vehicle plugs the extension cord into the host charging site the other end is plugged into the charging vehicles charging adapter. The adapter plugs into the vehicles standard charging plug. This adapter may be integral to the vehicle. The vehicle driver then presents their electronic key to the adapter to initiate charging. This prevents someone from stealing the adapter and using it on another vehicle. The charging adapter then “listens” for the host charging sites ID being transmitted over the AC wiring. If the vehicle adapter hears/decode a proper ID it then transmits its ID (for redundant record keeping) to the host site device. The host site device may then send several different commands to the vehicle adapter (to be discussed later). The charging vehicle then begins charging. The charging vehicle adapter meters the charging. The charging vehicle adapter may regulate the charging depending on local utility load shedding programs or depending on how many other vehicles may be charging on the same or different circuits with in the host site location.

During the charging many different data exchanges may occur between the charging vehicle and the host site. Primarily, if the host site ID adapter is network connected the charging vehicle with upload its charging history. This will be uploaded to the system's central accounting servers. A clearing command will sent back to the charging vehicle adapter confirming that the adapters charging history has been successfully relayed and therefore may be deleted from its local memory. The vehicle charging adapter also relays the charging history to the adapter's electronic key every time it is used. The vehicle owner is informed in a variety of ways that the charging history must be downloaded to the central accounting servers. If no network connected host charging site is used in the previous 30 days the vehicle owner must take the electronic key and a supplied USB style adapter and connect the two to a network connected computer where it will be downloaded to the central accounting servers. The electronic key memory will be updated and the 30 day timer refreshed. The electronic key will then update and refresh the vehicle charging adapter the next time it is used.

When the charging is completed the vehicle charging adapter records the event. The vehicle charging adapter will transmit a duplicate record to the host charging site ID device. The host charging ID device will transfer the charging event to the central accounting servers if network connected.

Once the charging vehicle charging events are transferred to the central accounting servers via a variety of means the central accounting servers will assign an appropriate kWH (kilowatt hour) rate for the host charging site utility, apply a nominal charging fee, debit the charging vehicle account and credit the host charging site account.

All charging and transaction events can be viewed by all members via the system's customer web site. Several other embodiments include:
The host charging site has a means to identify itself to the charging vehicle.
The charging vehicle has a means to identify the host charging site
Charging vehicle has a financial account to pay for charging typically associated with the users electric utility account, credit card account or debit card account.
Charging vehicle has an on board means to meter charge amount.
The use of power line carrier data communications to link an electric meter used to meter a charging electric vehicle to a network reporting device for the purpose of measuring, reporting and accounting the charging event with regards as to financial entity that gave the electricity and who received the electricity for the electric vehicle charging event.
A system that can utilize the existing premise wiring to charge, and account for the charging of an electric vehicle without the use of a dedicated electric meter on the AC circuit.
A system as described above but that can also use a dedicated charging circuit and meter whereby the charging vehicle meter and the dedicated meter communicate via power line carrier so as only on accounts for, and reports the charging event.
A electric vehicle charging system that uses power line carrier communications technology to identify the charging vehicle and charging site that employs a power line carrier signal filter located near the charging sites electric meter so as to prevent the power line carrier signals generated inside the charging facility premise from traveling past the facilities electric meter and out to another facilities electric meter and subsequently into the AC premise wiring of an adjacent premise This prevents the possibility of a charging vehicle connecting to an AC receptacle, receiving an authorized premise charging ID signal and commence charging but drawing the charge from the wrong electric meter circuit and therefore the system reimbursing the wrong meter owner.
Charging vehicle has a means to automatically transfer funds required to charging station for charge.
Charging vehicles existing general electric utility account or credit card is billed for charge and host charging site's general electric utility or credit card account is reimbursed for charge. The transaction maybe accounted for and provided through the charging entity host electric utility.
Charging station identifies charged entity.
Charging location is identified by GPS. This could be in conjunction with the power line carrier ID. The GPS location may be used to confirm authenticity. The GPS location may be the primary means to document a charging event. The GPS location would tie to an address/location owner database. The system would attempt to resolve the correct meter owner and may financial restitution.
Charging location is identified by location emitting an identifier via wireless or wire line (AC power line carrier (i.e. X10 style)) methods
Charging location has means to identify itself to charge entity by plugging in a power line carrier based identifier transmitting module into any AC receptacle ahead of the charging entities primary AC transformer and meter.
Charging vehicle has an electric metering device to measure amount of charging in kilowatts. The charging adapter has an embedded power meter to track electric power draw from the host site.
Charging vehicle, or charging adapter, or charging station connection post has a means to turn off, via relay or solid state transistor or triac type device the charging. This is primarily to allow for schedule, staggered charging for load leveling purposes. The charging post would use the switching capability to disallow charging for a non member, past due account connection request.
Charger ID may be sent/relayed back to charging station for validation prior to charging station allowing charging.
The charging adapter may have a non volatile electronic memory device to record charging events. Data stored from charging event may include:
   Host ID
   Date and time
   Whether charging was from a partner site or not. If not the adapter may ask the vehicle for its present GPS based location. This charging information may be coupled with location information to more fully document the charging event and habits of the vehicle and driver.
   Secondary host ids
   Charging history upload
   Charging preferences

In the discussion that follows, several terms and acronyms are used, including:

HCS, host charging site

HCSIDD, host charging Site ID Device

HCSM, host charging site electric circuit meter

HCSU, host charging site primary electric utility

HCSBU, host charging site billing utility

VCMI, vehicle charge module integrated

VCMA, vehicle charge module adapter

PHEV, Plug In Hybrid Electric Vehicle

CAS Central Accounting Servers

The protocol that effects this system may employ the following data types and messages:

HCSIDD ID broadcast

HCSIDD request to transfer data to specific

VCM broadcast initial response

HCSIDD AC power on/off time history

HCSIDD AC power quality report

In one embodiment, the charging vehicle adapter has an electronic key reader and associated electronic key or keys. The system user is provided a computer to key reading/writing device. The electronic key has a non volatile read/write memory. The electronic key reading technology may be based on the current Dallas Semiconductor “I” button technology or RF ID technology with onboard memory. The computer to key read/write device is likely a USB port based device with associated computer software. When the adapter is plugged into a computer the associated adapter software auto evokes. The user then presents the electronic key to the adapter. The electronic key is read for charging history data. If the host computer has global computer network (such as Internet) connectivity the keys charging history is transferred to the central administration computer system. If, after encrypted authentication of the key and charging data is performed, the charging data is marked as uploaded. The key is then likely downloaded data that the charging vehicle adapter will read the next time the electronic key is presented to the charging vehicle adapter. This data will enable the charging vehicle adapter to allow further subsequent charging. The charging vehicle adapter may prevent further charging if its charging history (and the financial viability of the adapter's owner) is not uploaded and confirmed. The charging vehicles adapter will display the number of charges till shut down on its built in display. This display presents other information to the charging vehicle adapter owner. The charging vehicle adapter can relay this charging/validation history to the central administration computers if any of the host site identifier devices is network connected. Any host site identifier device can perform the up load and refresh.

In one embodiment, the charging vehicle adapter has an internal clock that is reset to accurate time during any refresh/upload event.

In one embodiment, the Charging Adapter has stepped current draw circuits. The charging adapter may as the host charging site what is the recommended charging current and maximum charging current. The charging adapter may ask for priority charging as the vehicle owner indicated their intention to drive sooner than normal. The charging adapter may step up its current draw in increments to learn how much current may be draw.

In one embodiment, a charging station wall socket device that has a set of wall receptacle AC connection prongs and an AC receptacle plug. The device simply listens for the charging vehicles power line carrier ID and switches on a power transistor to allow charging. This device may or may not broadcast the host site ID and may or may not have charging event recording capabilities. It may simply serve as a way to prevent unauthorized charging from a vehicle that does not connect or have a vehicle identifier and charge recorder device. This device would likely always allow for up to one amp of current draw. It would have a means to sense the current draw. Upon sensing current draw (a completed circuit) the device would start a timer. The device would expect to see a valid vehicle ID via power line carrier with in the timer value. If it did then it would turn on the power transistor to enable full charging.

In one embodiment, the charging station may disallow charging if charged entity account is not validated or financially current.

In one embodiment, the charging entity may elect to be charged at variable rates depending on charging requirements dictated by travel requirements, the number of vehicles being charged at the location, the current cost of charging and or the current carrying capability of the local charging circuit.

In one embodiment, when more than one electric vehicle is plugged into the local charging site the charging site can, via grid knowledge or simple time scheduling, order the PHEVs to stagger their charging so as to not place a peak burden on the local charging site and grid.

In one embodiment, the host charging site ID device will listen for and identify a second (or more) host site ID device(s) and report this conflict to the central account servers via numerous means (these means to include via any HCSIDD network connection and the uploading of the event to any and all charging vehicle devices). The central accounting servers will generate a trouble ticket and prompt the system to contact the host site personnel.

In one embodiment, the central accounting system will check the local utility account of the HCSIDD to verify it is active prior to making a reimbursement. This is to prevent paying the wrong customer if the original customer has moved from the rented office space.

In one embodiment, the HCSIDD will have a clock and a means to run the clock without AC power. The HCSIDD will keep track of the time it is without AC power and transfer that history to the CAS. This AC on/off time may indicate that the HCSIDD is on a switched circuit and therefore after business hours charging may be prevented. The CAS may then contact the host site to rectify this.

In one embodiment, if charging vehicle is charged by a host with network connectivity the charged vehicle may send a completed charge to the host site interface that then sends the notice to the central server system. The central server system may then send an SMS text message to the charging vehicle owner that a charge has been completed. This text message may include details of the charge such as how much power was used, the estimated range of vehicle given the charge and the estimated cost of the charge.

In one embodiment, the Vehicle owner may call a system toll free number and via automate interactive voice services perform a number of system functions. The call will be automatically recorded and the call events stored with the customer notes in the CAS via a caller ID association as the CAS will have a reference phone number(s) for the vehicle owner. The vehicle owner can:

report a problem at a site,

retrieve current electric prices,

change charging preferences,

request charging status text messages,

record and report a charge at a non member site for documentation,

request the system contact a non member to advance membership.

In one embodiment, the host site charger ID unit may be designed in either a wall plug in style or a hardwired style. The initial site implementation will likely be a wall plug in style to allow easy installation. The host charging site is required to always be available for site ID purposes to charging vehicles. To prevent energy theft and tampering the host charging site device needs to be made tamper resistant. Toward that end the host charging site device may have a tamper plunger to detect and record when and how long the device might be unplugged. The plunger would reside in between or below the AC receptacle prongs. The plunger would retract into the device housing when plugged in and extend when unplugged. The plunger would likely be made of a non conductive material such as plastic. In one embodiment the plunger may be placed under one of the AC prongs and have a special receptacle cover in association with it. The receptacle cover would have a hole in it that the plunger would extend through. In this way someone could not slide a thin piece of plastic in between the plunger and the wall receptacle and there by remove the device without extending the plunger. If the plunger protruded slightly through the receptacle cover then it would be harder to hold in place if removed. Another version of the plunger may be to place it inside the ground prong on the device. In this manner the plunger would extend into the ground prong opening and be protected from tamper. The ground prong itself could be made into a plunger. The host charging site device would record when the plunger is a tamper condition and subsequently transmit the tamper event via its own communication link or to a charged vehicle adapter for subsequent reporting to the utility. The purpose of the report would be to document possible energy theft events by unplugging the host site ID device and then subsequently have the site charge a vehicle. This record of unplugging the host site device would be automatically compared to the charging records of the vehicles known to use the site. If the charging vehicles adapter/recorder has GPS records those might be compared also to identify energy theft.

One embodiment includes a system that text messages a user at a certain time (e.g., 9 pm) at night if the electric vehicle is not charging. Thus, the system provides a simple reminder until the user gets in the habit of charging.

Another embodiment includes a method and apparatus for controlling electric vehicle charging effects on peak demand usage for the host charging site. A system queries the driver as to their driving intentions so as to determine if the vehicle has adequate charge for the trip and if the vehicle should use the on board combustion engine for charging or should wait till it can be charged via electrical connection to the grid. The vehicle simply asks the question of “how far are you going now.” The system may have an onboard GPS and computer to learn the drivers travel habits and ask questions based on those learned habits.

Another embodiment includes a method and apparatus for grid stability which supply high speed charging devices. High rate of charge devices can cause electric grid stability issues in addition to high peak demand electric prices. This unique system balances the high speed charging rates with a slow constant grid draw. The system pairs super capacitors or like devices at the electric vehicle and at the charging station resulting in a regulated slow charge into the station side super capacitor bank which provides the periodic high speed discharge to the charging electric vehicle.

In another embodiment a flat wire that can be quickly laid on a side walk without causing a pedestrian hazard is produced. The wire inside the flat (⅛″) is actually a wire mesh. It could possibly be a foil for higher current carrying capabilities. The wire would be about 4 to 6 inches wide and would be capable of being repeatedly stepped on. The wire would come in a flexible or rigid insulating material. The flexible version would be used for temporary applications. The rigid version would be for permanent installations. The rigid flat conductor wire would be designed to be cut into the needed length and then, using a crimp on style device, crimp on the connection ends. These connection ends on the interior of the crimp have hundreds of small spikes that penetrate the insulation and connect to the wire mesh, there by conducting electricity. Other then providing conductivity the connection ends also provide anchoring holes and form factor conversions to standard wire or conduit.

A version of this device designed to run electricity under standard business entry/exit doors. It flat wire would be in a half circle form and have an AC plug on one end and an AC receptacle on the other. The form factor would allow users to place the assembly under either (opening or hinge side) side of a door to run electric power outside without interfering with the door operation or presenting a pedestrian trip hazard. The wire may have a layered cover that when worn away by the door rubbing on it changes color to indicate the wear and potential shock hazard. The device covering may have a separate layer of fine wire that is above the electric conductor layer. If there is rubbing wear then the fine wires might be exposed. A fault circuit could be built into the device that when wires are cut or come in contact with each other a circuit breaker in the plug (upstream) side would trip therefore breaking the main current carrying circuit and preventing the potential shorting/contact of the main wires to the door frame thus creating a shock hazard.

The HCSIDD (charger side plug in device) will have a method to detect and record times when the plug in device is physically removed from the wall socket.

The electric car or the charging adapter will emit an identifying signal via the power line carrier technology that identifies it as an electric car. This is so the supplier side can allow/disallow charging on the circuit, control the amount of charging and bill for the charging.

The charger receiver will have a local electronic key. This electronic key will likely be a RF ID tag/receiver that will identify the owner/driver of the car. It may be a Bluetooth style transceiver. The Bluetooth style transceiver has an advantage that the fob device could hold the cars charging history and be used to transfers the history from the car to a portal of communication. For convenience sake the local electronic key ID will be kept active in the receiving cars charging computer for 5 minutes after the last key read. The key will attempt to be read when the car is put in park and/or turned off. This will allow the driver to hook up to the charging station without re-presenting the key yet still disable the charge adapter if it is stolen or copied.

Security: There will be numerous security checks and balances to detect, report, track and disable unauthorized charging.

If the host site exterior charging receptacle is not in a charging post style but rather a wall style receptacle, then the receptacle is marked in style or verbiage indicating that it is intended for vehicle charging only and requires a user fob for operation.

On the charging adapter device there may be keypad. The keypad would be used to enter an alpha or numeric code into the adapter before the charging begins and only if the charge adapter “hears” more than one host charging device ID. In multi-tenant properties member host charging sites will be given signage announcing their participation in the charging program (actually all host site members will be given signage as part of their initial kit). This signage will have a letter or number prominently displayed on the sign. If the vehicle owners charging adapter detects more than one host site ID device then the charge adapter will/may prompt the vehicle owner to enter in the “sign” code. The sign code will be transmitted to the host site ID device and the charging adapter will also keep a record of the code entered. This code will become part of the charging event record. All host site IDs being received by the vehicle charging adapter will become part of the charging event record. The sign code was associated with the unique host site ID device at the time the account was set up. The sign code can be issued fairly randomly as 1) this occurrence should not happen that much and 2) the sign simply has to be different than the sign code associated with the neighboring host charging site sign code. Since the sign is in front of or generally geographically associated with the host site that the vehicle charging adapter is connected the proper host site ID can be deduced by the central accounting servers once the charging record is uploaded.

The above possible issue of a vehicle charging adapter receiving more than one host site IDs can be addressed and assessed by another methodology other than the associated site sign code. This issue occurs when two or more host site charging adapters are broadcasting their site IDs on premise AC wiring that is separated by electric meters but not by transformers and therefore one sites ID signal passes through the electric meters and into each others premise wiring. Given this, one of the broadcast site ID signals should be stronger at the vehicle charging adapter device. All host site ID devices will broadcast (transmit) their ID signal at the same output power. Since one device ID signal does not pass through electric meters and additional AC premise wiring it should be stronger. Therefore a vehicle charging adapter could identify the proper host site ID in a multi ID environment by assigning the charge to the strongest host site ID.

In an attempt to prevent the above multi ID issue a signal filter or choke device can be placed on or around the AC wiring as the wire leaves the sites main circuit breaker panel. This would be the last accessible AC wiring before the electric meter and the subsequent electric meters in the multi tenant premise. By attenuating the power line carrier technology signal at this point one could ensure that the host site ID was broadcast to all site AC wiring receptacles but not further. The filtering or choke would likely take the form of a coil style filter designed to attenuate, squelch or nullify the frequency of the power line carrier technology used.

The charging vehicle adapter described here in may use a standard US or European style 3 prong plug and receptacle. The vehicle charging adapter could well be incorporated into an inductance paddle style charging connection. The connection style should not matter except if the charging adapter is built into the vehicle and is an inductive paddle style. This is because the inductive paddle acts as a transformer and will not likely pass the power line carrier signal. Therefore a capacitive coupling circuit will need to built into the paddle and integrated charging adapter circuit in the vehicle to pass the power line signal through the paddle and onto the premise AC wiring.

Another embodiment includes a method and apparatus to meter, account and report electric vehicle charging. A simplistic embodiment of the electric vehicle charging system may be implemented by a stand alone device that connects to the host charging site premise AC circuit and meters, records and reports, locally on the device or via a network connection the charging event. The device would be designed to either be operated by the host site or be portable and operated by the transient electric vehicle. The unique aspect to the device is its ability to not only measure and record the charging events but to translate the charging event immediately into a payable report. The device could have a network connection for determination of current electricity costs at the approximate location of charging. The device could be programmed to know which local utility it was connected to better ascertain what the local cost of electricity is. The device could have a network connection and a built in web server so as charging event records could be viewed remotely via computer. The device could be used as a stand alone electric vehicle charging metering, accounting and reporting system.

Another embodiment includes a curb cable. Above is described a flat cable scheme to allow a charging cable to pass underneath a premise exterior door in a manner that is safe and allows the door to fully open and close without a pedestrian hazard due to its semi circular and flat shape. In addition to that concept it is recognized that many charging infrastructure installations will require that the electric cabling be run along the edge of a building wall or along an existing street curb. Without the invention described below this would have to be done via trenching with existing underground electric cable or by routing the AC cable through metal conduit. Both options present an expensive and less than optimal durability solution. By producing a high current cable sheathed in a flexible, durable plastic or rubberized casing extruded in a right angle triangle shape then an easier, less expensive to install, more durable solution can be realized. The right angle edge of the cable would position against the wall/road or curb/road edge. The sloped outer edge would face the road surface. The right angle edge of the cable would be rounded. The cable would have mounting holes that run through the cable in a perpendicular route to the cable length. These holes would allow masonry bolts to run through the cable into the road surface to secure the cable to the road. This presentation allows vehicle wheels to encounter the hypotenuse of the cable with low chance of crushing the cable as the wheel might if existing round electrical conduit were used. Additionally, the presentation presents a more aesthetically pleasing installation of cable. The cable system would have field installed end caps and vertical cable routing fixtures. These fixtures would allow for proper waterproof sealing and electrical insulation.

Another embodiment includes a circuit and network load leveling system. When permanent AC circuits are installed to charge electric vehicles they will have cable and circuit beaker rated for a maximum voltage and amperage. These circuits may have additional charging receptacles added at a later time. Different electric vehicles may have different charging current draw. There will be various numbers of electric vehicles connected to a specific charging circuit at any point in time. Additionally, these various electric vehicles will be in various states of completion of charging on various charging demand schedules and therefore may requirement different current draw requirements from the specific circuit. The invention provides two levels of solutions for this problem. The invention is in two parts. First, add the ability for the network controller of the charging circuit to identify how many vehicles desire to, or are charging at any point in time. Add the ability for the network to vary and limit how much electric current can pass through any specific charging connection point at any particular point in time. In this manner the network can allow individual vehicles to charge at a maximum rate without exceeding the circuit's current carrying capability. These capabilities also can prevent individual vehicles from presenting a load to the common circuit that result in the common circuit breaker opening and thus preventing all vehicles from charging. By adding the ability for the network to identify the current draw of each charging vehicle via the associated electric charging points electric meter (whether the meter was part of the charging point fixture or part of the vehicle) the network can determine which electric vehicle is presenting an excessive current draw. This feature would allow the network to identify the offending vehicle and limit or disconnect a vehicle from the individual circuit and therefore allow the circuit breaker to automatically reset and allow charging for the other vehicles to continue. The circuit load awareness feature can also provide the feature of allowing certain vehicles to charge at varying rates in accordance with the time frame needed by type of battery being charged or by the time frame needed by the vehicle owner. If the owner needed a quicker charge time the network may accommodate this and also allow for a premium charging fee to be assessed to the requesting vehicle.

The circuit load awareness feature could apply to charging points that are network connected by wireless radio devices but this would require tying the charging point address and circuit ID in programming the networks central controller.

The circuit load awareness and charge progress awareness couples with text message notification feature mentioned herein that makes a vehicle owner aware of when a charging event is completed or if a charging event is prematurely stopped. This feature becomes more important for electric only, non hybrid vehicles.

Another embodiment employs short range wireless transceivers to broadcast the host site ID to a radio transceiver in the electric vehicle adapter which also contains the electric meter for measuring and recording the charging event. Because the radio transceivers broadcast in an omnidirectional pattern there is likelihood that if two host sites were adjacent that the vehicle adapter would not know which one to use. Therefore, this embodiment incorporates a simple letter or number code being placed on signage in front to the host charging site. At the time that the vehicle owner initiates charging they enter the host site ID into the vehicle charging adapter. The charging adapter broadcasts the ID. The proper host site transceiver replies back as it knows the sites “sign code” as it was entered into the host site ID device at the time of site enrollment into the system.

Another embodiment incorporates the function of the host site ID devices transmitting vehicle specific information over the communications link on to the vehicle manufacturer for diagnostic and warranty reasons. The unique aspect of this function is that the system normally sends data between the vehicle, host site and central administration computer system. In this variation, vehicle specific information unrelated to the charging event would be diverted to a network connection operated by the vehicle manufacturer of other service entity, but not to the central administration computer used for administering the charging event. In this manner the individual vehicle manufacturers could get proprietary information directly from the vehicle without fear of the data becoming public. This transfer of proprietary data would likely be a secondary function of the charging system.

Another embodiment allows for the function of programming the central administrative computer with a specific charging plug receptacle's maximum current carrying capability. The central administration computer would download this data to the appropriate host site ID device, which in turn would control the specific receptacle via commands an variable current circuit embedded in the specific receptacle. In this manner the system could prevent a charging vehicle from requesting more current from a circuit than it was capable of providing.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A recharging trailer for applying electrical energy to an electric vehicle having an electrical power coupling, comprising:
a. a trailer frame configured to be coupled to the electronic vehicle;
b. an electrical generation unit, disposed on the trailer frame, configured generate electrical power and configured to be electrically coupled to the electrical power coupling of the electric vehicle; and
c. a trailer propulsion unit configured to propel the trailer while the electrical vehicle is moving so that the trailer moves without applying a substantial load to the electric vehicle.

2. The recharging trailer of claim 1, further comprising:
a. a load sensor configured periodically to sense changes of speed of the electric vehicle and configured to generate a vehicle speed signal representative thereof; and
b. a controller responsive to the vehicle speed signal and configured to adjust a parameter of the trailer propulsion unit so that the recharging trailer will have a speed that matches the speed of the electric vehicle.

3. The recharging trailer of claim 2, wherein the load sensor comprises at least one strain sensor that is mechanically coupled to both the trailer and to the electric vehicle.

4. The recharging trailer of claim 2, wherein the load sensor comprises at least one accelerometer disposed on the trailer frame.

5. The recharging trailer of claim 1, wherein the trailer propulsion unit includes:
a. a motor configured to provide motive power to the trailer; and
b. a controller that receives control input from the electrical vehicle, wherein the controller is configured to transmit control signals to the motor so as to regulate the speed of the motor.

6. The recharging trailer of claim 1, wherein the trailer includes at least one wheel and wherein the trailer propulsion unit comprises:
a. a trailer-mounted electric motor that is electrically coupled to the electrical generation unit; and
b. a drive assembly coupled to the trailer-mounted electric motor and configured to provide motive power to the at least one wheel of the trailer,
wherein the electrical generation unit is configured to provide electrical power to both the electric vehicle and the trailer-mounted electric motor in an amount sufficient to drive both the electric vehicle and the recharging trailer.

7. The recharging trailer of claim 6, wherein the electrical generation unit comprises an electrical energy storage system.

8. The recharging trailer of claim 7, wherein the electrical energy storage system comprises a storage system selected from a group of storage systems consisting of: a battery of electro-chemical storage cells and super capacitors.

9. The recharging trailer of claim 1, wherein the electric generation unit is configured both to generate power sufficient to recharge batteries in the electric vehicle and to propel the electric vehicle.

10. The recharging trailer of claim 1, wherein the electrical generation unit comprises:
a. an electrical generating unit;
b. a fuel powered engine configured to provide motive rotational force to the electrical generating unit; and
c. a controller configured to control the engine.

11. The recharging trailer of claim 10, wherein the fuel powered engine comprises a motor selected from a group consisting of: an internal combustion engine and a gas turbine engine.

12. The recharging trailer of claim 10, further comprising a liquid fuel storage tank.

13. The recharging trailer of claim 1, wherein the electrical generation unit comprises a fuel cell.

14. The recharging trailer of claim 1, further comprising a trailer coupler that is complimentary to an electric vehicle-mounted coupler and that is incompatible with a standard trailer hitch, thereby interfering with coupling of the trailer to a vehicle that lacks a electric vehicle-mounted coupler.

15. The recharging trailer of claim 1, further comprising a location device coupled to the trailer configured to indicate a location of the trailer to a remote station.

16. The recharging trailer of claim 15, wherein the location device comprises a global positioning system-based security system.

17. The recharging trailer of claim 15, wherein the location device comprises a device that is configured to activate the location device when the trailer is disconnected from the electric vehicle.

18. The recharging trailer of claim 1, further comprising low speed self propulsion system that facilitates movement of the trailer while the trailer is disconnected from the electric vehicle by transmitting movement control signals from a user to the trailer propulsion unit.

19. A recharging trailer for applying electrical energy to an electric vehicle having an electrical power coupling, comprising:
a. a trailer frame, including at least one wheel, configured to be coupled the electronic vehicle;
b. an electrical generation unit, disposed on the trailer, including an electrical generating unit configured generate electrical power and configured to be electrically coupled to the electrical power coupling of the electric vehicle, the electrical generation unit also including an electrical energy storage system configured to store electrical energy generated by the electrical generating unit;
c. a trailer propulsion unit configured to propel the trailer while the electrical vehicle is moving so that the trailer moves without applying a substantial load to the electric vehicle, the trailer propulsion unit including
i. a trailer-mounted electric motor that is electrically coupled to the electrical generation unit and that receives electrical power therefrom; and
ii. a drive assembly coupled to the trailer-mounted electric motor and configured to provide motive power to the at least one wheel of the trailer;
d. a load sensor configured periodically to sense changes of speed of the electric vehicle and configured to generate a vehicle speed signal representative thereof; and
e. a controller responsive to the vehicle speed signal and configured to adjust a parameter of the trailer propulsion unit so that the recharging trailer will have a speed that matches the speed of the electric vehicle.

20. A method of providing electrical power to an electric vehicle, comprising the actions of:
a. generating electrical power using an electrical generation unit mounted on a trailer that is mechanically coupled to the electric vehicle;
b. supplying at least some of the electrical power from the electrical generation unit to the electric vehicle;
c. propelling the trailer with a trailer propulsion unit;
d. sensing changes in electric vehicle momentum periodically; and
e. adjusting a momentum of the trailer in response to changes in electric vehicle momentum sensed in the sensing action.

21. The method of claim 20, wherein the propelling action comprises drawing current from the electrical generation unit and supplying the current to an electrical motor that is mounted on the trailer and that is configured to supply motive power to at least one wheel of the trailer.
